(19) United States
(12) Patent Application Publication
(10) Pub. No.: US 2012/0105419 A1
(43) Pub. Date: May 3, 2012

(54) Driving Circuit for Liquid Crystal Pixel Array and Liquid Crystal Display Using the Same

(75) Inventors: Wen-Lin Yang, Sinshih Township (TW); Shih-Yu Wen, Sinshih Township (TW)

(73) Assignee: HIMAX TECHNOLOGIES LIMITED, Sinshih Township (TW)

(21) Appl. No.: 12/913,804

(22) Filed: Oct. 28, 2010

(51) Int. Cl. G09G 3/36; G06F 3/038

(52) U.S. Cl. 345/212; 345/96

(57) ABSTRACT

A driving circuit with reduced power consumption and a liquid crystal display using the same. The driving circuit includes at least a power circuit, a source driver and a VCOM driver. The power circuit is coupled to a power supply to receive a power signal to generate a positive supply voltage and an inverted power signal. The source driver includes a first source operational amplifier. The first source operational amplifier is powered by the positive supply voltage and a power ground, to couple a positive polarity display voltage to a first terminal of a first display capacitor of a pixel array. The VCOM driver includes a VCOM operational amplifier. The VCOM operational amplifier provides a second terminal of the first display capacitor with a VCOM voltage, and a negative power terminal of the VCOM operational amplifier is coupled to the inverted power signal.

### BACKGROUND OF THE INVENTION

1. Field of the Invention

The present invention relates to a liquid crystal display (LCD), and in particular relates to a driving circuit driving a liquid crystal pixel array of the LCD.

2. Description of the Related Art

A liquid crystal display (LCD) is a thin, flat electronic visual display that uses the light modulating properties of liquid crystals. Liquid crystals do not emit light directly. An image is displayed by controlling the transmission of the liquid crystals.

For each liquid crystal pixel, it is only the magnitude of the applied voltage that determines the light transmission. To prevent polarisation (and rapid permanent damage) of the liquid crystal material, the polarity of the applied voltage is reversed on alternate video frames. Several polarity inversion techniques have been developed, which include line inversion, dot inversion and column inversion. FIG. 1A illustrates a dot inversion technique. FIG. 1B illustrates a column inversion technique. To summarize, the polarity of each pixel is reversed in each frame, and two adjacent pixels (such as a first pixel P1 and a second pixel P2) located in the same row and adjacent columns are always of opposite polarities.

Reference to a common voltage (hereinafter, VCOM voltage), may used to represent display polarity. When the applied voltage is greater than the VCOM voltage, a positive polarity display is provided. On the contrary, when the applied voltage is lower than the VCOM voltage, a negative polarity display is provided. Consequently, the signals provided by the driving circuit of the liquid crystal pixel array of the LCD cover a wide range. If the driving circuit is not properly designed, considerable power may be consumed. A driving circuit with reasonable power consumption is called for.

### BRIEF SUMMARY OF THE INVENTION

Liquid crystal displays (LCDs) and driving circuits thereof are disclosed.

The driving circuit is operative to drive a liquid crystal pixel array of the LCD, and comprises at least a power circuit, a source driver and a VCOM driver.

The power circuit is coupled to a power supply to receive a power signal. Based on the power signal, the power circuit generates at least a positive supply voltage and an inverted power signal.

The source driver comprises a first source operational amplifier. The first source operational amplifier is powered by the positive supply voltage and a power ground, to couple a positive polarity display voltage to a first terminal of a first display capacitor of the pixel array.

The VCOM driver comprises a VCOM operational amplifier. The VCOM operational amplifier provides a second terminal of the first display capacitor with a VCOM voltage. The VCOM operational amplifier has a positive power terminal and a negative power terminal. The negative power terminal of the VCOM operational amplifier is coupled to the inverted power signal while the positive power terminal of the VCOM operational amplifier is coupled to the power signal or the power ground.

In some exemplary embodiments, the power circuit comprises at least a first charge pump and a second charge pump. The first charge pump generates the inverted power signal based on the power signal. The second charge pump generates the positive supply voltage based on the power signal. The voltage level of the positive supply voltage may be twice as great as that of the power signal.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A illustrates a dot inversion technique;

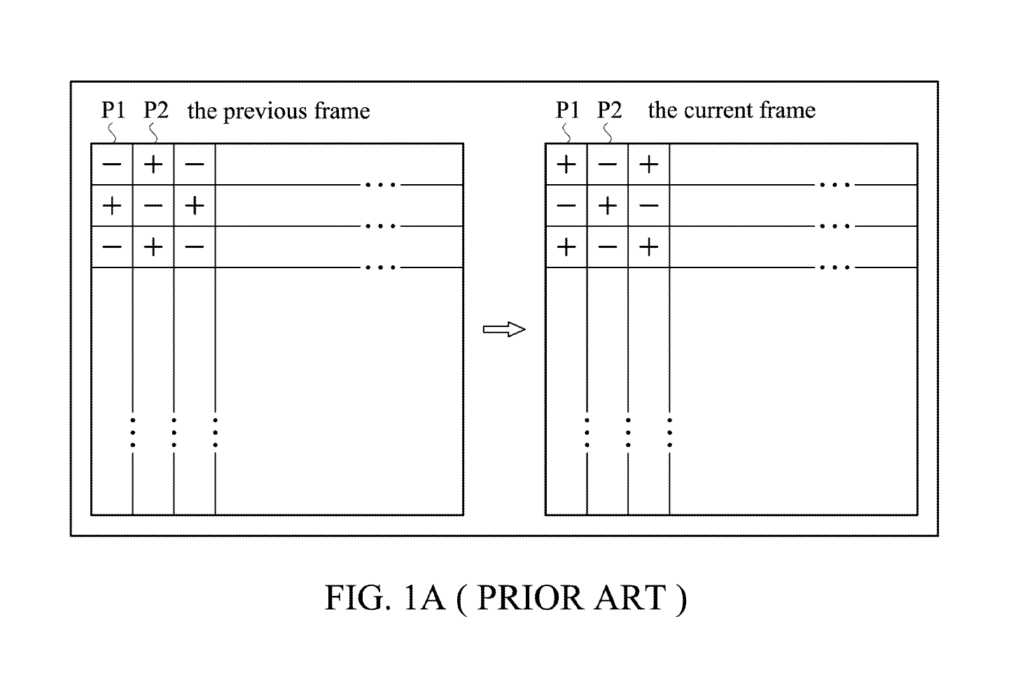

FIG. 1B illustrates a column inversion technique;

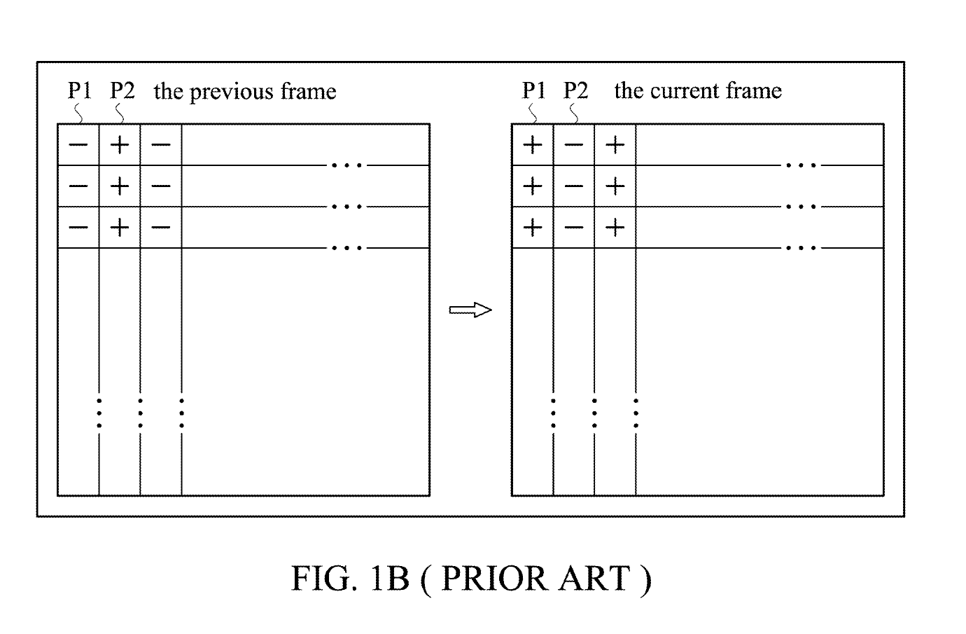

FIG. 2 is a block diagram illustrating a liquid crystal display 200 according to an embodiment of the invention;

FIG. 3 shows an exemplary embodiment of the disclosed power circuit;

FIG. 4A shows two adjacent pixels, on the same row and adjacent columns, of the liquid crystal pixel array 202; and

FIG. 4B uses two display capacitors C1 and C2 to represent the two adjacent pixels of FIG. 4A, and illustrates the essential driving circuit for the two adjacent pixels.

### DETAILED DESCRIPTION OF THE INVENTION

The following descriptions show several embodiments carrying out the invention. This description is made for the purpose of illustrating the general principles of the invention and should not be taken in a limiting sense. The scope of the invention is best determined by reference to the appended claims.

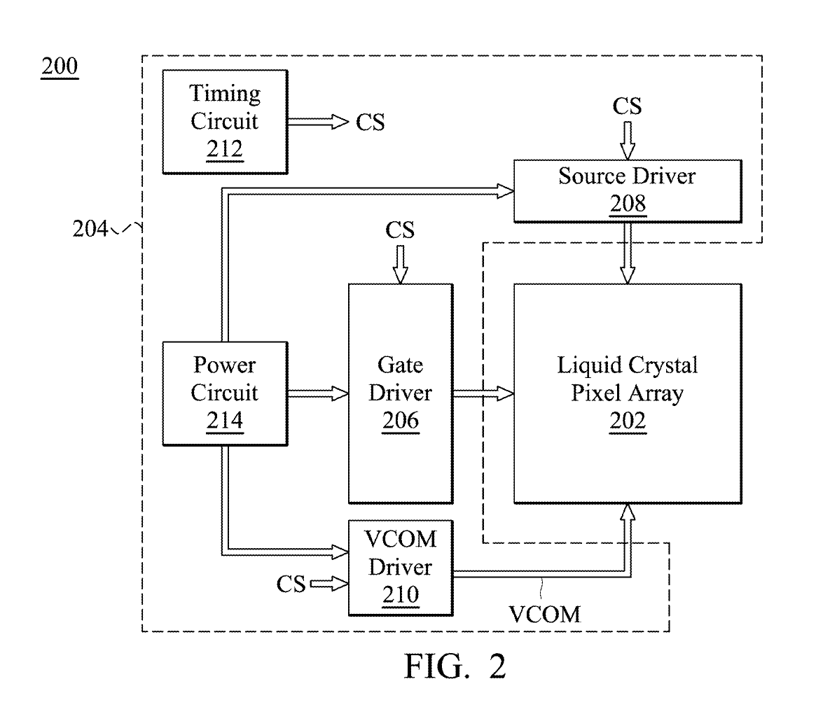

FIG. 2 is a block diagram illustrating a liquid crystal display 200 according to an embodiment of the invention. The liquid crystal display 200 comprises a liquid crystal pixel array 202 and a driving circuit 204. The driving circuit 204 comprises a gate driver 206, a source driver 208, a VCOM driver 210, a timing controller 212 and a power circuit 214.

The timing controller 212 outputs control signals CS to control the gate driver 206, source driver 208 and the VCOM driver 210. For example, the gate driver 206 is controlled by the timing controller 212 to scan the liquid crystal pixel array 202 row by row. The source driver 208 is controlled by the timing controller 212 to provide the scanning pixels with display voltages. The VCOM driver 210 is controlled by the timing controller 212 to provide the liquid crystal pixel array 202 with a VCOM voltage (labeled VCOM).

The power circuit 214 is designed to power the components within the gate driver 206, the source driver 208 and the VCOM driver 210. In the invention, the circuit of the power circuit 214 is specially designed to power the components of the VCOM driver 210 and thereby power consumption of the driving circuit 204 is considerably reduced.

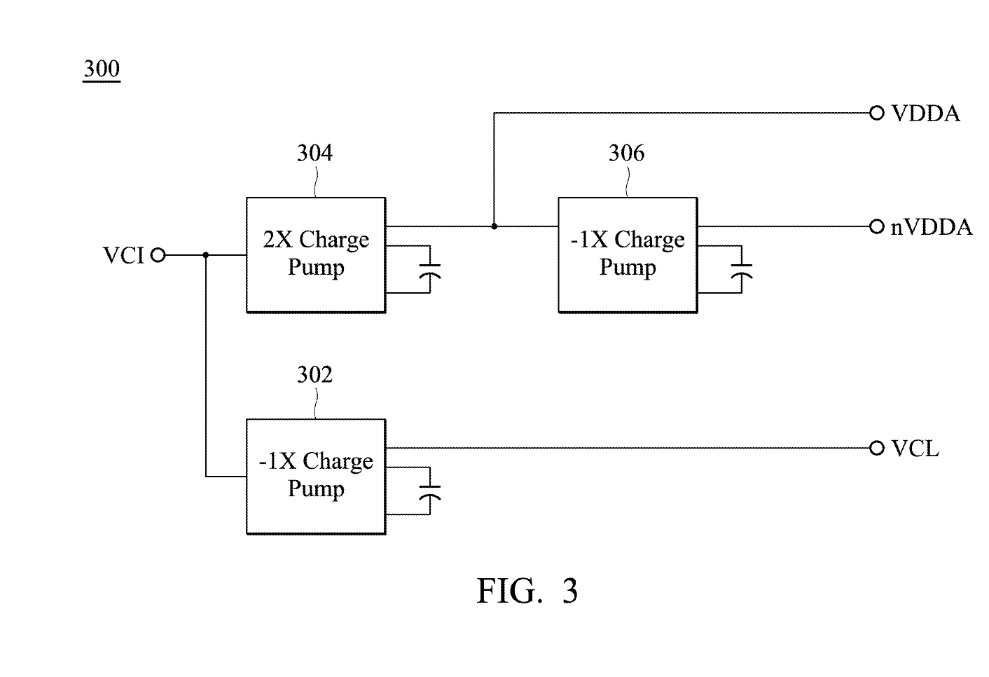

FIG. 3 shows an exemplary embodiment of the disclosed power circuit. The power circuit 300 receives a power signal VCI from a power supply, and generates a positive supply voltage VDDA, an inverted power signal VCL or even a negative supply voltage nVDDA based on the power signal VCI.

In this embodiment, the power circuit 300 comprises a first charge pump 302, a second charge pump 304 and a third charge pump 306. Based on the power signal VCI, the first charge pump 302 generates the inverted power signal VCL, which may be an inverted signal of the power signal VCI. The first charge pump 302 may be a −1X charge pump. The second charge pump 304 is designed to generate the positive supply voltage VDDA based on the power signal VCI. A voltage level of the positive supply voltage VDDA may be twice as great as that of the power signal VCI. The second charge pump 304 may be a 2X charge pump. The third charge pump 306 is coupled to the second charge pump 304, to generate the negative supply voltage nVDDA based on the positive supply voltage VDDA. The negative supply voltage nVDDA may be an inverted signal of the positive supply voltage VDDA. The third charge pump 306 may be a −1X charge pump.

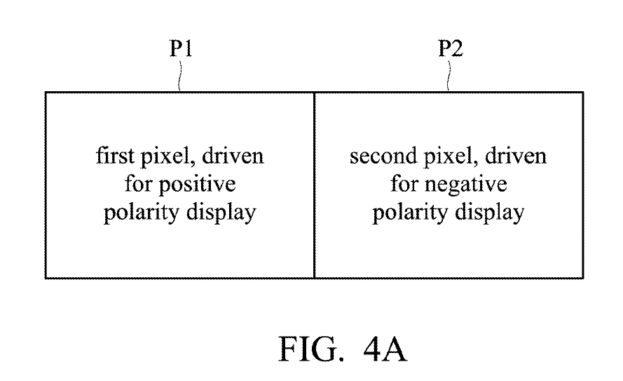

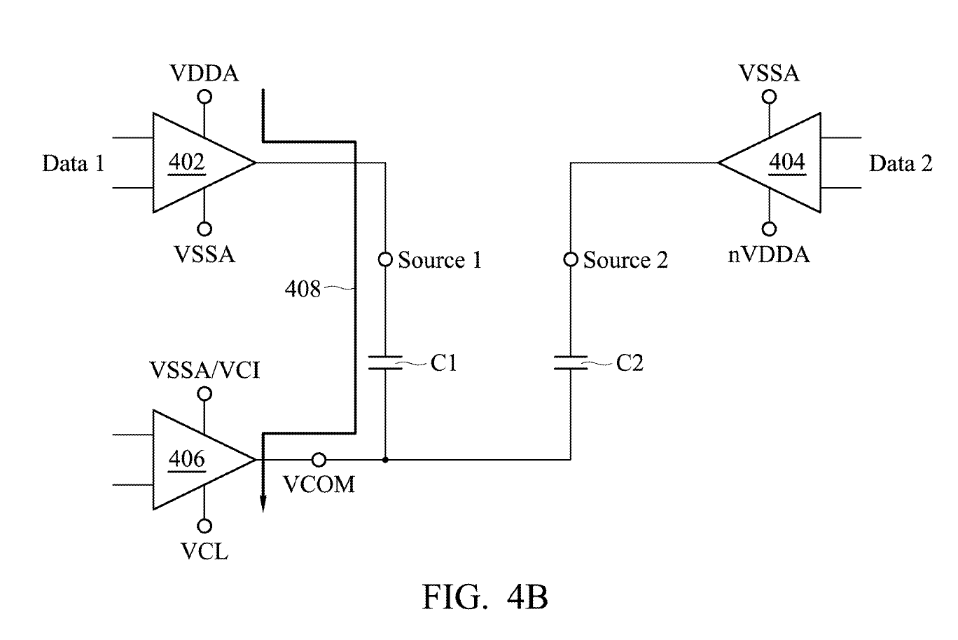

How to use the disclosed power circuit to power the source driver 208 and the VCOM driver 210 of the driving circuit 204 is discussed in the following paragraphs. For simplicity, only two adjacent pixels (in the same row and adjacent columns) of the liquid crystal pixel array 202 are shown in the following discussion. FIG. 4A shows two adjacent pixels (one is named a first pixel P1 while the other is named a second pixel P2), wherein for a current frame, the first pixel P1 is driven to show positive polarity display and the second pixel P2 is driven to show negative polarity display. In FIG. 4B, a first display capacitor C1 is shown to represent the first pixel P1, a second display capacitor C2 is shown to represent the second pixel P2, and three operational amplifiers 402, 404 and 406, provided by the source driver 208 and the VCOM driver 210 of the driving circuit 204, are shown to explain how the first display capacitor C1 is charged for positive polarity display and how the second display capacitor C2 is discharged for negative polarity display.

The operational amplifiers 402 and 404 are named a first source operational amplifier and a second source operational amplifier, respectively, and are provided by the source driver 208 of the driving circuit 204. The operational amplifier 406 is named a VCOM operational amplifier and is provided by the VCOM driver 210 of the driving circuit 204. The VCOM operational amplifier 406 is operative to generate the VCOM voltage (VCOM of FIG. 2).

The first source operational amplifier 402 is powered by the positive supply voltage VDDA (generated by the power circuit 300) and a power ground (named VSSA), to couple a positive polarity display voltage Data1 to the first terminal (labeled as Source1) of the first display capacitor C1. The second terminal of the first display capacitor C1 is coupled to a common terminal VCOM to receive the VCOM voltage from the VCOM operational amplifier 406. In this regard, the first pixel P1 (corresponding to the first display capacitor C1) is driven for positive polarity display.

The second source operational amplifier 404 is powered by the power ground VSSA and the negative supply voltage nVDDA (generated by the power circuit 300), to couple a negative polarity display voltage Data2 to the first terminal (labeled as Source2) of the second display capacitor C2. The second terminal of the second display capacitor C2 is coupled to the common terminal VCOM to receive the VCOM voltage from the VCOM operational amplifier 406. In this regard, the second pixel P2 (corresponding to the second display capacitor C2) is driven for negative polarity display.

The VCOM operational amplifier 406 has a positive power terminal and a negative power terminal. In this invention, the negative power terminal of the VCOM operational amplifier 406 is specifically coupled to the inverted power signal VCL (provided by the power circuit 300), however, there are many ways to power the positive power terminal of the VCOM operational amplifier 406. For example, the positive power terminal of the VCOM operational amplifier 406 may be coupled to the power ground VSSA or may directly receive the power signal VCI.

The charging path 408 shows that only a voltage difference, VDDA-VCL, is required to charge the first display capacitor C1. In comparison with conventional techniques wherein the negative power terminal of the VCOM operational amplifier is coupled to the negative supply voltage nVDDA (which is twice the as great as the VCL), the minimized voltage difference, VDDA-VCL, considerably reduces the power consumption of the total driving circuit.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving circuit for a liquid crystal pixel array, comprising:
a power circuit, coupled to a power supply to receive a power signal to generate a positive supply voltage and an inverted power signal;
a source driver, comprising a first source operational amplifier, which is powered by the positive supply voltage, and a power ground to couple a positive polarity display voltage to a first terminal of a first display capacitor of the pixel array; and
a VCOM driver, comprising a VCOM operational amplifier providing a second terminal of the first display capacitor with a VCOM voltage, wherein, a negative power terminal of the VCOM operational amplifier is coupled to the inverted power signal.

2. The driving circuit as claimed in claim 1, wherein the power circuit comprises a first charge pump which generates the inverted power signal based on the power signal.

3. The driving circuit as claimed in claim 2, wherein the power circuit further comprises a second charge pump which generates the positive supply voltage based on the power signal.

4. The driving circuit as claimed in claim 3, wherein a voltage level of the positive supply voltage is twice as great as that of the power signal.

5. The driving circuit as claimed in claim 1, wherein a positive power terminal of the VCOM operational amplifier is coupled to the power ground.

6. The driving circuit as claimed in claim 1, wherein a positive power terminal of the VCOM operational amplifier is coupled to the power signal.

7. The driving circuit as claimed in claim 1, wherein:
the power circuit further generates a negative supply voltage;
the source driver further comprises a second source operational amplifier, which is powered by the power ground and the negative supply voltage to couple a negative polarity display voltage to a first terminal of a second display capacitor of the pixel array; and
the VCOM driver further couples the VCOM voltage to the second terminal of the second display capacitor.

8. The driving circuit as claimed in claim 7, wherein the power circuit comprises a first charge pump which generates the inverted power signal based on the power signal.

9. The driving circuit as claimed in claim 8, wherein the power circuit further comprises a second charge pump which generates the positive supply voltage based on the power signal.

10. The driving circuit as claimed in claim 9, wherein a voltage level of the positive supply voltage is twice as great as that of the power signal.

11. The driving circuit as claimed in claim 10, wherein the power circuit further comprises a third charge pump which receives the positive supply voltage and generates the negative supply voltage which is an inverted signal of the positive supply voltage.

12. A liquid crystal display, comprising:
the driving circuit of claim 1; and
the liquid crystal pixel array driven by the driving circuit.
